(19) United States
(12) Patent Application Publication
(10) Pub. No.: US 2024/0005608 A1
(43) Pub. Date: Jan. 4, 2024

(54) Travel in Artificial Reality

(71) Applicant: Meta Platforms Technologies, LLC, Menlo Park, CA (US)

(72) Inventors: Joshua Jacob INCH, Eastsound, WA (US); Zoe SINNER, San Ramon, CA (US); Kris NARUNATVANICH, San Francisco, CA (US); Michael MACADAAN, Los Angeles, CA (US); Eyal OHANA, San Francisco, CA (US); Zhe WANG, Palo Alto, CA (US); Danyang ZHAO, San Mateo, CA (US); Sarah HASSAN, San Jose, CA (US); Brian Michael JEW, Seattle, WA (US)

(21) Appl. No.: 18/447,758

(22) Filed: Aug. 10, 2023

Related U.S. Application Data
(60) Provisional application No. 63/380,295, filed on Oct. 20, 2022.
(60) Provisional application No. 63/376,621, filed on Sep. 22, 2022.
(60) Provisional application No. 63/371,315, filed on Aug. 12, 2022.

(51) Int. Cl. G06T 19/00

(52) U.S. Cl. CPC G06T 19/003

(57) ABSTRACT

In some implementations, the disclosed systems and methods a user can be at a source location (e.g., XR environment, two-dimensional webpage/browser, etc.) and input received can trigger traveling the user to a target XR environment (e.g., an immersive environment). In some implementations, the disclosed systems and methods a user can spawn a virtual portal in an origin virtual world for travel to a destination virtual world for the creating user and a group of other users having avatars near that of the creating user. In some implementations, the disclosed systems and methods a user can be at a source location (e.g., XR environment, two-dimensional webpage/browser, etc.) and input received can trigger traveling the user to a target XR environment (e.g., an immersive environment).

### CROSS REFERENCE TO RELATED APPLICATIONS

This application claims priority to U.S. Provisional Application Nos. 63/371,315 filed Aug. 12, 2022 and titled “Travel Experience when Transitioning to a Target Artificial Reality Environment,” 63/376,621 filed Sep. 22, 2022 and titled “Virtual Portals for Travel Between Virtual Worlds in an Artificial Reality Experience,” and 63/380,295 filed Oct. 20, 2022 and titled “Invitation Links To Artificial Reality Destinations.” Each patent application listed above is incorporated herein by reference in their entireties.

### BACKGROUND

Display systems can display content to users in a variety of formats that match user preferences or use cases. However, content can have a variety of display configurations, and effectively displaying content in accordance with user selections and/or expectations remains a challenge. For example, content that includes immersive experiences can have a variety of different configurations that are specific to design choice, implemented technology, model selection, or other suitable configurations. Due to this diversity, users can encounter unexpected display artifacts, transitions, and/or navigation that fails to achieve intuitive results. In addition, when a user enters an immersive experience, a mismatch between user expectations and the presented world can be disorientating and may result in ineffective user interactions with the world.

Users interacting with artificial reality (XR) devices can view content in an artificial reality environment that includes real-world objects and/or two-dimensional (2D) and/or three-dimensional (3D) virtual objects. For example, the artificial reality environment can be a virtual environment depicted by a virtual reality (VR) device showing a set of virtual objects. As another example, the artificial reality environment can be a mixed reality environment with real-world objects and virtual objects supplemented over the real-world objects. A user can view the objects in the artificial reality environment and modify content in the artificial reality environment.

Applications can exist that can operate on both XR interfaces and two-dimensional (2D) interfaces. A 2D interface can be a flat surface that can display 2D content, such as objects, graphics, text, etc. For example, a 2D interface can be part of a laptop computer, mobile device, television, etc. On the 2D interface, XR content can be rendered and interacted with differently than on an XR interface due to the limitations of a 2D interface as compared to a fully immersive XR experience.

### SUMMARY

Aspects of the present disclosure are directed to traveling a user from a source environment to a target artificial reality (XR) environment. For example, a user can be at a source location (e.g., XR environment, two-dimensional webpage/browser, etc.) and input received can trigger traveling the user to a target XR environment (e.g., an immersive environment). A travel experience component can display information that prepares the user for the target XR environment, such as a target location within the target XR environment, a depiction of the user's presence and/or a user identifier, a loading bar that estimates completion of loading the target XR environment, one or more social connections (e.g., other users) at the target XR environment, a preview of the target XR environment, and any other suitable information. In some implementations, the target XR environment can be configurable using interface elements at the travel experience component.

Further aspects of the present disclosure are directed to virtual portals for travel between virtual worlds in an artificial reality (XR) experience. Some implementations can allow a user to spawn a virtual portal in an origin virtual world for travel to a destination virtual world for the creating user and a group of other users having avatars near that of the creating user. Travel through the virtual portal can guarantee that the creating user and the group of nearby users end up in the same instance of the destination virtual world, without being in a party. Although the virtual portal can be visible to all users in the origin virtual world, some implementations can reserve slots only for the group of nearby users.

Additional aspects of the present disclosure are directed to providing invitation links to artificial reality (XR) destinations. Some users have multiple user interfaces (e.g., XR interfaces and/or two-dimensional (2D) interfaces) that are capable of rendering an XR destination. Some implementations can provide an invitation link that allows a user to jump to an XR destination, including across applications. Some implementations allow a user to select from which user interface he wants to access the XR destination. The next time he powers on and/or dons the selected user interface, the selected user interface can automatically load the XR destination.

### BRIEF DESCRIPTION OF THE DRAWINGS

FIG. 1 illustrates an example component of a travel experience presented to a user while transitioning to an artificial reality environment.

FIG. 2 illustrates another example component of a travel experience presented to a user while transitioning to an artificial reality environment.

FIG. 3 illustrates an example user interface configured to receive input from a user to trigger an artificial reality environment transition.

FIG. 4 illustrates an example component of a travel experience presented to a user after the user triggers an artificial reality environment transition.

FIG. 5 illustrates an example component of a travel experience with interface elements presented to a user while traveling to an artificial reality environment.

FIG. 6 is a flow diagram illustrating a process used in some implementations of the present technology for traveling a user from a source environment to a target artificial reality (XR) environment.

FIG. 7A is a conceptual diagram illustrating an example of a virtual menu displayed in an origin virtual world to request generation of a virtual portal to a destination virtual world.

FIG. 7B is a conceptual diagram illustrating an example of a virtual portal in an origin virtual world for travel to a destination virtual world.

FIG. 7C is a conceptual diagram illustrating an example of a destination virtual world when accessed via a virtual portal.

FIG. 8 is a flow diagram illustrating a process used in some implementations for traveling from an origin virtual world to a destination virtual world in an artificial reality experience.

FIG. 9A is a conceptual diagram of an example message including an invitation link to an artificial reality destination.

FIG. 9B is a conceptual diagram of an example user interface selection page that can be displayed upon activation of an invitation link associated with an artificial reality destination.

FIG. 9C is a conceptual diagram of an example landing page that can be displayed upon powering on or donning of a selected user interface.

FIG. 10 is a flow diagram illustrating a process used in some implementations for providing an invitation link to an artificial reality destination.

FIG. 11 is a block diagram illustrating an overview of devices on which some implementations of the present technology can operate.

FIG. 12 is a block diagram illustrating an overview of an environment in which some implementations of the present technology can operate.

### DESCRIPTION

Aspects of the present disclosure are directed to traveling a user from a source environment to a target artificial reality (XR) environment. For example, a user can be at a source location (e.g., source XR environment, source two-dimensional webpage/browser, etc.) and input received from the user can trigger traveling the user to a target XR environment, such as an immersive environment displayed to the user via an XR system. In some implementations, a client system (e.g., XR system) displays the source environment, target XR environment, and one or more travel experiences to the user. For example, a transition manager can configure the client system to dynamically transition a display, to the user, from: a) the source environment (e.g., prior to the triggering of a transition to a target XR environment); b) to a travel experience (e.g., after triggering the transition); and c) to the target XR environment (e.g., once the target XR environment has loaded).

In some implementations, the source environment and/or target XR environment can be displayed to the user via a two-dimensional or XR browser. A browser, such as a web browser, can display content from a public network (e.g., the Internet) via the host of a webpage, a content distribution network, or any other network source of web content. An artificial reality browser can be configured to display both a two-dimensional display to a user, such as a standard webpage, and an immersive experience, such as the target XR environment. A two-dimensional webpage/website may be a traditional 2D panel or may include some three-dimensional content, such as a three-dimensional model that is provided in association with the webpage or that is viewed with parallax effects. The browser can retrieve/receive resources according to the execution of code and/or scripts (e.g., JavaScript) implemented as part of the webpage/web content to display two-dimensional webpages/websites, a source XR environment, a target XR environment, or any other suitable display. The source environment, travel experience, and/or target XR environment can be displayed the user via any other suitable software component.

In some implementations, in response to input from a user (e.g., a button press at the source environment), the transition manager configure a travel experience for display to the user. For example, the travel experience can support an intuitive transition for the user from a source environment to a target XR environment or an intuitive entry into the XR environment for the user. The travel experience can include a component, such as a panel, that displays information about the user, the target XR environment, or any suitable combination. The travel experience can also include a background, one or more animations, a loading sequence, or any other suitable elements.

Implementations of the travel experience can prepare the user for the target XR environment. For example, immersion into an XR environment can be disorienting when the experience does not comply the user expectations. The travel experience panel (e.g., a two-dimensional interface) can display information that prepares the user for the target XR environment, such as a target location within the target XR environment, a depiction of the user's presence and/or a user identifier, a loading bar that estimates completion of loading the target XR environment (or completion of the travel experience), one or more social connections (e.g., other users) at the target XR environment, a preview of the target XR environment (e.g., static image of the environment, image/video of a spawn point at the XR environment), an icon/image the represents the target XR environment, and any other suitable information.

In some implementations, the target XR environment can be configurable using interface elements at the travel experience panel. For example, the user can interact with the interface elements to configure the target XR experience. Example configuration that can be set by the user via the travel experience panel include a target initial location within the target XR environment, a user presence for the target XR environment (e.g., avatar selection), a user's privacy settings in the target XR environment, or any other suitable configuration for the target XR environment. Implementations of the travel manager can configure the target XR environment according to user input received at the travel experience panel. For example, the user's entry into the target XR environment can be configured according to the input received at the travel experience panel.

In some implementations, the XR environment can be a three-dimensional environment and/or immersive environment defined by received/retrieved XR environment resources, such as one or more models (e.g., shells, vfx models, wireframes, etc.), graphic files (e.g., backgrounds, images spread over wireframes, shells, and/or models, etc.), code (e.g., JavaScript, binary files, etc.), and other suitable immersive resources. For example, when the source environment is also an XR environment, the travel manager can transition the user from a first three-dimensional environment to a second three-dimensional environment. The user can travel between three-dimensional environments using any suitable travel mechanism, such as when the user's presence (e.g., avatar) enters a portal within the source XR environment that travels the user to the target XR environment. In this example, the travel experience displayed to the user while the user travels from the source to the target can orient the user and achieve a more comfortable, informed, and intuitive transition. In another example, when the source environment is a two-dimensional environment, such as a webpage, the travel manager can transition the user from a two-dimensional setting to a three-dimensional setting. In this example, the travel experience displayed to the user can prepare the user for the transition from a two-dimensional environment to a three-dimensional environment, and also achieve a more comfortable, informed, and intuitive transition.

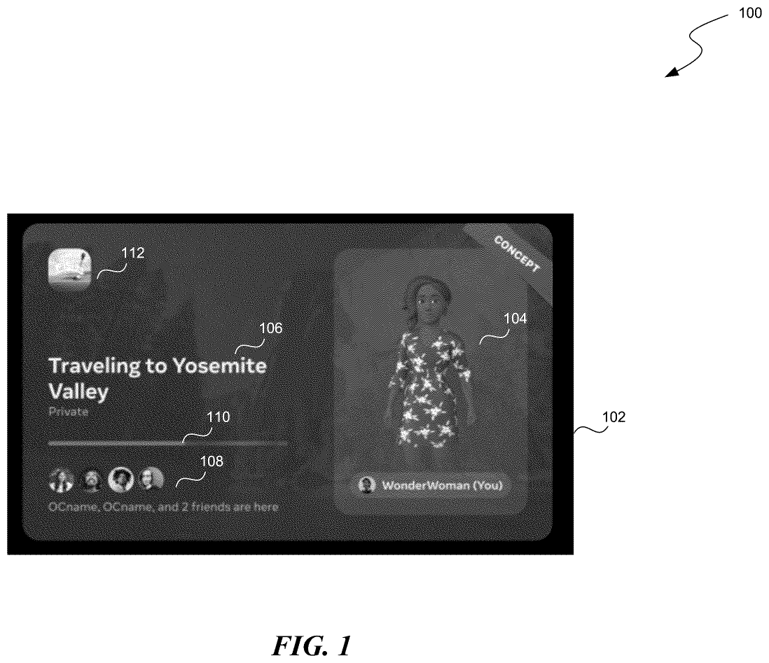

Implementations of the travel experience can include one or more different versions of travel experience component(s). FIG. 1 illustrates an example component of a travel experience presented to a user while transitioning to an artificial reality environment. Diagram 100 includes component 102, user presence 104, environment location 106, social links 108, load indicator 110, and XR environment indicator 112. For example, component 102 can be portion of a travel experience displayed to the user in response to a triggered transition from a source environment to a target XR environment. Component 102 can include user information, such as user presence 104 (e.g., the avatar that will represent the user upon entry to the target XR environment) and social links 108 (e.g., the social network connections, such as other users, present in the target XR environment). Any other user information relevant to the target XR environment can be displayed by component 102.

Component 102 can also include target XR environment information, such as environment location 106 (e.g., the identifier of the location where the user will enter the XR environment), load indicator 110 (e.g., a status bar that indicates the load progress for the XR environment), and XR environment indicator 112 (e.g., an icon associated with the XR environment, preview static image of the XR environment and/or specific location within the XR environment, a preview video of the XR environment and/or specific location within the XR environment, etc.). Any other target XR environment information relevant to the user can be displayed by component 102. Component 102 can display this user information and/or target XR environment information during the travel experience to support an intuitive transition/entry to the target XR environment for the user.

While component 102 is displayed to the user, resources for the target XR environment can be loaded. For example, load indicator 110 can indicate the load progress for the resources. In some implementations, one or more portions of JavaScript code can load XR environment resources (e.g., retrieve the resources from a web source, configure/initialize the resources using a script, etc.). When the XR environment is loaded, the display to the user can be dynamically altered to stop displaying the travel experience and component 102 (e.g., fade out the travel experience display), and start displaying the loaded XR environment (e.g., fade in the entry location of the XR environment).

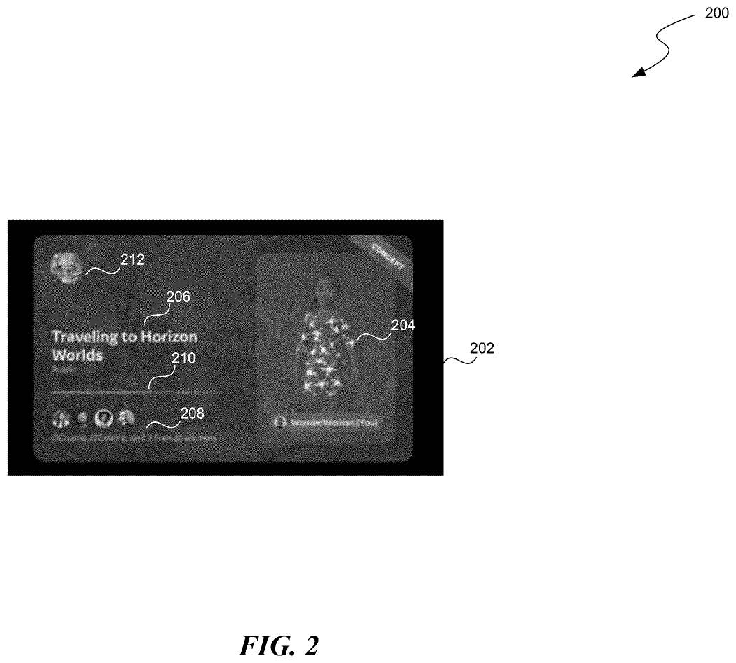

FIG. 2 illustrates another example component of a travel experience presented to a user while transitioning to an artificial reality environment. Diagram 200 includes component 202, user presence 204, environment location 206, social links 208, load indicator 210, and XR environment indicator 212. Component 202 of FIG. 2 can be similar to components described above. For example, user presence 204, environment location 206, social links 208, load indicator 210, and XR environment indicator 212 can be similar to components described above.

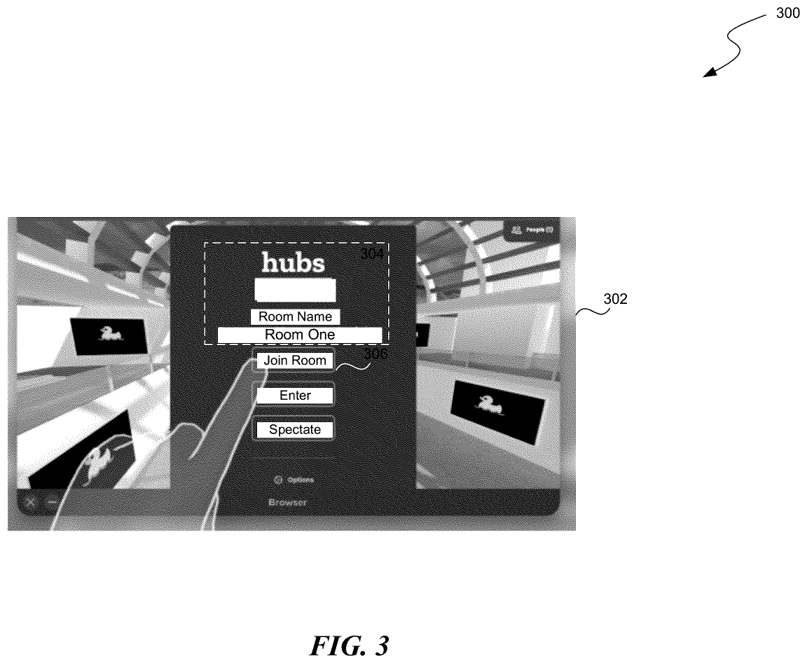

Implementations display the travel experience to a user when the user provides input that triggers transition to a target XR environment. FIG. 3 illustrates an example user interface configured to receive input from a user to trigger an artificial reality environment transition. Diagram 300 includes component 302, target XR environment indicator 304, and initiation element 306. For example, component 302 can be displayed to a user via a browser (e.g., XR browser), and the user can interact with component 302 to transition from the two-dimensional source environment displayed by the browser to a three-dimensional target XR environment. In some implementations, indicator 304 can be one or more fields that include descriptor(s) or identifier(s) for the target XR environment, a specific location within the target XR environment, or any other suitable target XR environment elements.

Initiation element 306 can be an interface component (e.g., button) that the user interacts with to trigger a transition from the source environment (e.g., two-dimensional display at the XR browser) to the target XR environment (e.g., three-dimensional immersive experience). In response to receiving input from the user via initiation element 306, the display to the user can be dynamically altered from the source environment to a travel experience.

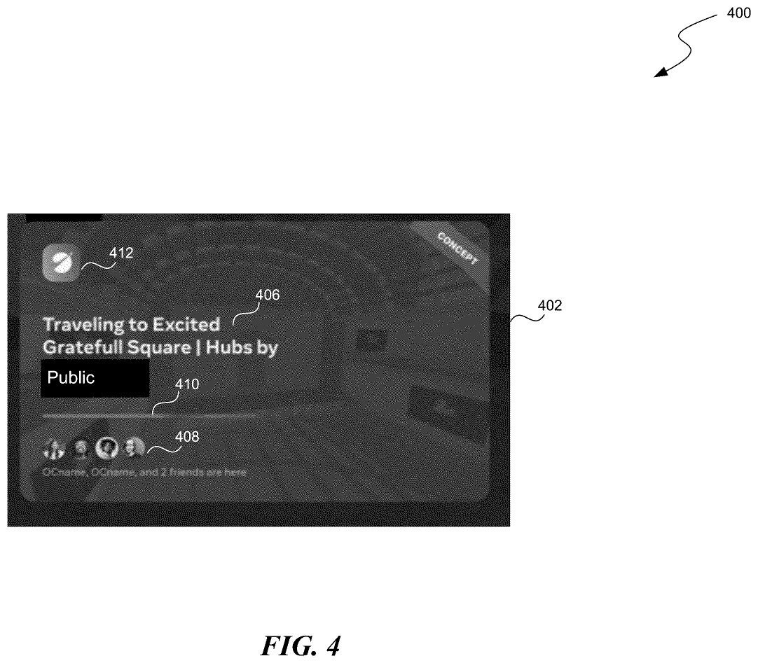

FIG. 4 illustrates an example component of a travel experience presented to a user after the user triggers an artificial reality environment transition. Diagram 400 includes component 402, environment location 406, social links 408, load indicator 410, and XR environment indicator 412. In some implementations, component 402 can be displayed to the user after the user triggers transition to a target XR environment via above-described components. Component 402 of FIG. 4 can be similar to components described above. For example, environment location 406, social links 408, load indicator 410, and XR environment indicator 412 can be similar to above described components. Implementations of a travel experience component can also include interface elements that support user configuration of the target XR environment.

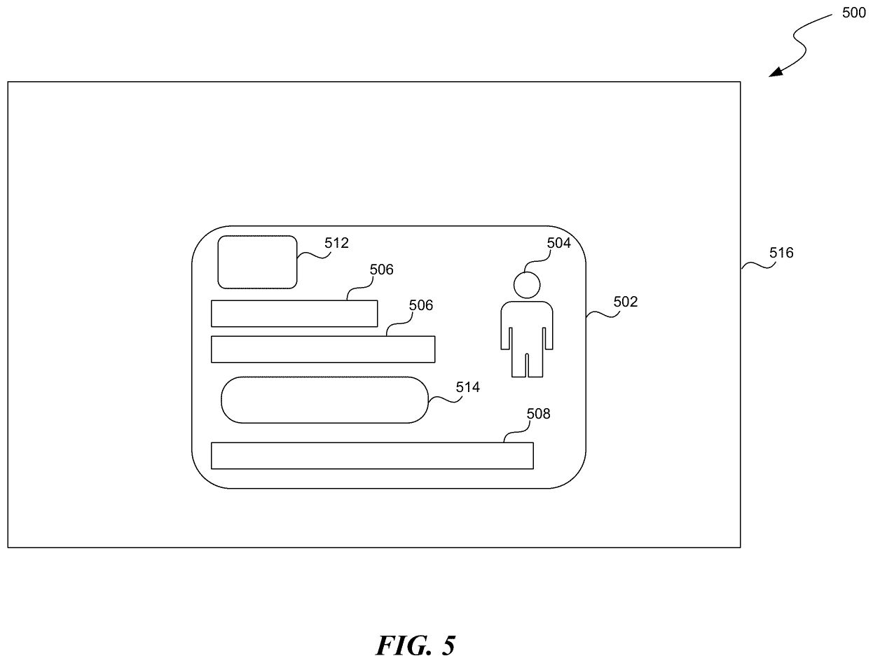

FIG. 5 illustrates an example component of a travel experience with interface elements presented to a user while traveling to an artificial reality environment. Diagram 500 includes component 502, user presence 504, environment location 506, social links 508, load indicator 510, and XR environment indicator 512, interface element 514, and background 516. In some implementations, user presence 504, environment location 506, social links 508, load indicator 510, and XR environment indicator 512 can be similar to components described above.

Component 502 can also include interface element 514, which can include one or more elements that the user can interact with to configure the XR environment that the user is being traveled to and/or user information for the user's experience in the XR environment. For example, interface element 514 can include a user presence selection element which supports the user's selection of a predetermined, predefined, or other suitable user presence variation (e.g., version of the user's avatar). In some implementations, user presence 504 can be dynamically altered to display the user presence variation selected using interface element 514.

In some implementations, interface element 514 can also be used to select user privacy settings for the XR environment. In an XR environment, a user can selectively share the experience with other collocated users based on the user's personal privacy settings. For example, other users can be permitted to view, talk with, team up with (e.g., on a quest or other predetermined scenario), or otherwise interact with the user. In some implementations, an interface element (e.g., drop down menu) can be prepopulated with preset privacy settings selectable by the user. Example privacy settings that can be set via interface element 514 include: public visibility and audio interactions, public visibility and semi-private audio interactions (e.g., limited to social network links, members of a predetermined group, etc.), semi-private visibility and semi-private audio interactions, semi-private visibility and private audio interactions (e.g., no permitted audio interactions with other users), private visibility (e.g., not visible to other users) and private audio interactions, any combination thereof, or any other suitable privacy settings.

In some implementations, interface element 514 can also be used to select a specific location at which the user enters the target XR environment. For example, an interface element (e.g., drop down menu) can be prepopulated with possible locations for the user within the target XR environment. Implementations of environment location 506, social links 508, load indicator 510, and/or XR environment indicator 512 can be adjusted according to the location selected by the user via interface element 514. Any other suitable XR environment configurations can be set by the user via input using interface element 514.

In some implementations, the input received from the user via interface element 514 can be transmitted to a computing device that implements the XR environment and/or a user's experience with the XR environment. For example, an application programming interface call can be made to applications running at one or more cloud devices, edge devices, and/or servers to configure the user's experience at the XR environment.

In some implementations, component 502 (e.g., a foreground component) can be displayed on background 516. For example, background 516 can include any suitable background related to the target XR environment, such as visual depictions of the XR environment (e.g., images, videos, etc.) and/or a specific location within the XR environment.

In some implementations, versions of a travel experience can include information about the user's source environment. For example, identifiers, descriptors, a user's presence within the source environment, the user's location within the source environment, images and/or videos of the user's location within the source environment, or other suitable information can be displayed by component(s) of the travel experience (e.g., a foreground component, a background component, etc.).

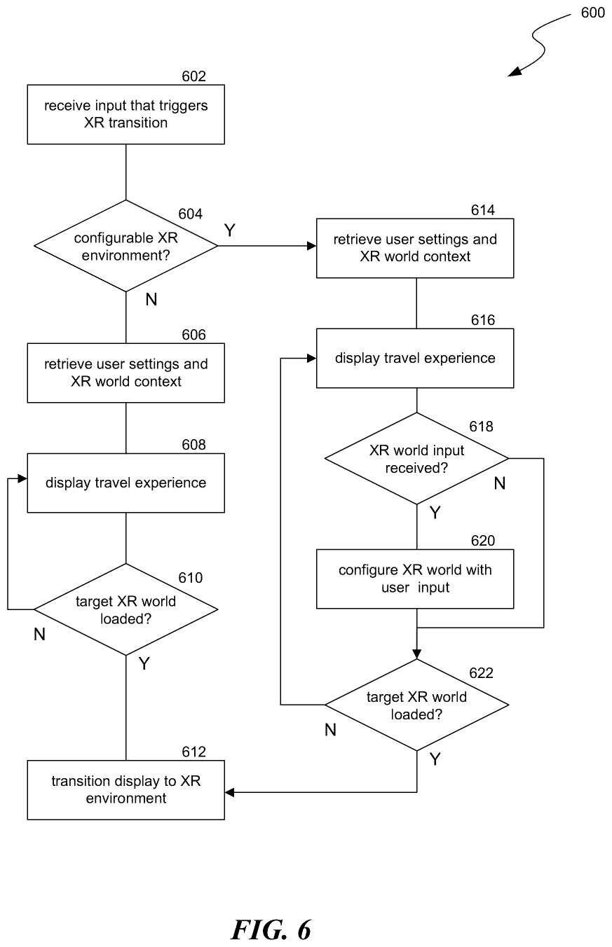

FIG. 6 is a flow diagram illustrating a process used in some implementations of the present technology for traveling a user from a source environment to a target artificial reality (XR) environment. In some implementations, process 600 can be performed when user input (or any other suitable trigger) triggers a transition from a source environment to a target XR environment. In some implementations, process 600 is performed at a server (e.g., cloud server, edge server, etc.) that transitions the user's client system (e.g., XR system) from the source environment to the target XR environment or on the client system itself.

At block 602, process 600 can receive input that triggers transition from the source environment to the target XR environment. For example, an interface can be displayed to the user (e.g., via an XR browser or any other suitable software), such as an interface that is part of a two-dimensional source environment (e.g., webpage, two-dimensional navigation software for an application, etc.), a three-dimensional source environment (e.g., immersive experience, three-dimensional navigation software for an application, etc.), or any combination thereof. The user can interact with the interface to trigger a transition from the source environment to a target XR environment, such as press a button, select an interface element, or any other suitable trigger interaction. In some implementations, any other suitable trigger can cause the transition from the source environment to the target XR environment.

At block 604, process 600 can determine whether the XR environment is configurable by travel experience component. For example, a variation of a transition experience can include a component that can configure the target XR environment for the user. In some implementations, an exposed API by one or more computing systems that implement the target XR environment can be used to detect whether the XR environment can be configured by the travel experience component. When the XR environment is configurable by travel experience component, process 600 can progress to block 614. When the XR environment is not configurable by travel experience component, process 600 can progress to block 606.

At block 606, process 600 can retrieve user information and/or target XR environment context. For example, context about the target XR environment, such as the specific location where the user will enter the target XR environment, descriptor(s) for the environment/location, images or videos for the XR environment/location, and other suitable target XR environment context can be retrieved. In some implementations, user information can be retrieved, such as the user presence variation (e.g., avatar) for the target XR environment, user privacy settings, social connections present in the target XR environment, and other suitable user information.

At block 608, process 600 can display a travel experience to the user. For example, the XR environment context and user information retrieved at block 606 can be displayed to the user via a travel experience component. In some implementations, a transition effect (e.g., fade out and fade in, animation, etc.) can be displayed to the user to transition from display of the source environment to display of the travel experience.

In some implementations, resources for the target XR environment can be loaded (e.g., at the client system, and one or more computing devices that implement the XR environment for the client system, etc.) while the travel experience is displayed to the user. For example, target XR environment resources can include one or more models (e.g., shells, vfx models, wireframes, etc.), graphic files (e.g., backgrounds, images spread over wireframes, shells, and/or models, etc.), code (e.g., JavaScript, binary files, etc.), and other suitable XR environment resources.

At block 610, process 600 can determine whether the target XR environment has loaded. For example, the XR environment resources can be loaded at one or more computing devices in order to implement the target XR environment for the user. Load statuses can be provided by software executing at the one or more computing devices that indicates when the target XR environment is loaded and ready for deployment. When the target XR environment has loaded, process 600 progresses to block 612. When the target XR environment has not loaded, process 600 progresses back to block 608, where the travel experience continues to be displayed until the XR environment has loaded.

At block 612, process 600 transitions from, display of the travel experience to display of the target XR environment. In some implementations, a transition effect (e.g., fade out and fade in, animation, etc.) can be displayed to the user to transition from display of the travel experience to display of the target XR environment.

At block 614, process 600 can retrieve user information and/or XR environment context. For example, context about the target XR environment, such as the specific location where the user will enter the target XR environment, descriptor(s) for the environment/location, images or videos for the XR environment/location, and other suitable target XR environment context can be retrieved. In some implementations, user information can be retrieved, such as user presence variation(s) (e.g., avatar) for the target XR environment, user privacy settings, social connections present in the target XR environment, and other suitable user information.

At block 616, process 600 can display a travel experience with XR environment interface elements to the user. For example, the XR environment context and user information retrieved at block 614 can be displayed to the user, for example via a travel experience component. In some implementations, a transition effect (e.g., fade out and fade in, animation, etc.) can be displayed to the user to transition from display of the source environment to display of the travel experience.

In some implementations, the travel experience component can include one or more elements that the user can interact with to configure the target XR environment and/or user information for the user's experience in the target XR environment. For example, the travel experience component can include a user presence selection element which supports the user's selection of a predetermined, predefined, or other suitable user presence variation (e.g., version of the user's avatar).

In some implementations, the travel experience component can also be used to select user privacy settings for the XR environment. For example, an interface element (e.g., drop down menu) can be prepopulated with preset privacy settings selectable by the user. Example privacy settings include: public visibility and audio interactions, public visibility and semi-private audio interactions (e.g., limited to social network links, members of a predetermined group, etc.), semi-private visibility and audio interactions, semi-private visibility and private audio interactions (e.g., no permitted audio interactions with other users), private visibility (e.g., not visible to other users) and private audio interactions, any combination thereof, or any other suitable privacy settings.

In some implementations, the travel experience component can also be used to select a specific location at which the user enters the target XR environment. For example, an interface element (e.g., drop down menu, map interface, etc.) can be prepopulated with possible locations for the user within the target XR environment. Any other suitable XR environment configurations can be set by the user via input using the travel experience component.

At block 618, process 600 can determine whether XR environment input has been received from the user. For example, the travel experience component can include one or more elements that can receive input from the user, such as drop-down menus, selection boxes, free form text fields, and any other elements. The software that implements the elements can be configured to detect when input is received from the user and/or the user can select a component that indicates input has been submitted (e.g., press a submit button). When XR environment input has been received from the user, process 600 can progress to block 620. When XR environment input has not been received from the user, process 600 can progress to block 622.

At block 620, process 600 can configure the XR environment with received user input. For example, the input received from the user via the travel experience component can be transmitted to one or more computing devices/software applications that implement the XR environment and/or a user's experience with the XR environment. In some implementations, an application programming interface call can be made to applications running at one or more cloud devices, edge devices, and/or servers to configure the user's experience at the XR environment.

At block 622, process 600 can determine whether the target XR environment has loaded. For example, the XR environment resources can be loaded at one or more computing devices in order to implement the target XR environment for the user. Load statuses can be provided by software executing at the one or more computing devices that indicates when the target XR environment is loaded and ready for deployment. When the target XR environment has loaded, process 600 progresses to block 612. When the target XR environment has not loaded, process 600 progresses back to block 616, where the travel experience can continue to be displayed, user input can continue to be received, and the XR environment can continue to be configured by the user input until the XR environment has loaded.

Conventionally, for a group of users to the same instance of a virtual world, they will form a “party,” (i.e., a formal association between the users indicating to a host system that the users of the party should be kept together). However, parties can be high friction and require multiple steps before traveling together (e.g., forming a party invitation, accepting the party invitation, inviting the party to travel, accepting the travel invitation, traveling to the virtual world, etc.). Aspects of the present disclosure address these problems and others by providing virtual portals for travel between virtual worlds in an artificial reality (XR) experience. A user can create a virtual portal in an origin virtual world that can allow the user, as well as other users having avatars near that of the user, to travel to a same instance of a destination virtual world without being in a party. Thus, the virtual portal can ensure that a group of friends having avatars near each other in an origin virtual world, or an ad-hoc group of users near each other that meet and want to travel together, can continue the XR experience together.

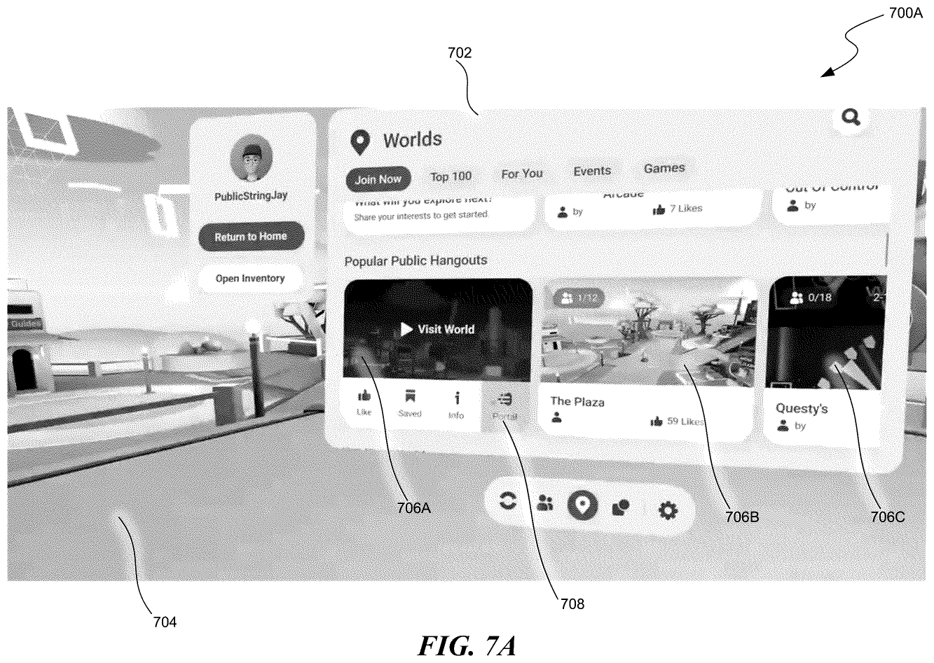

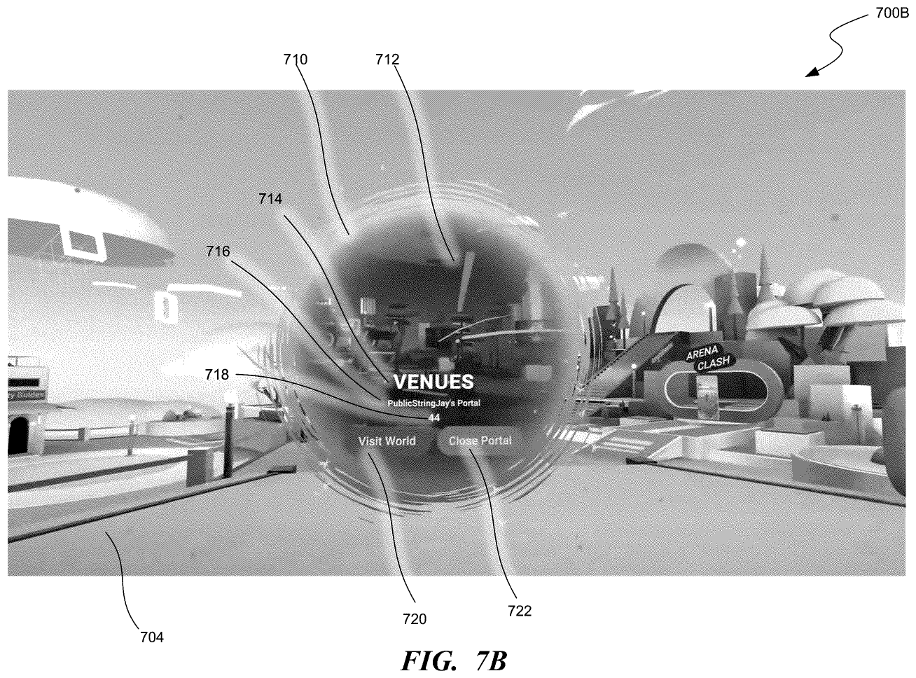

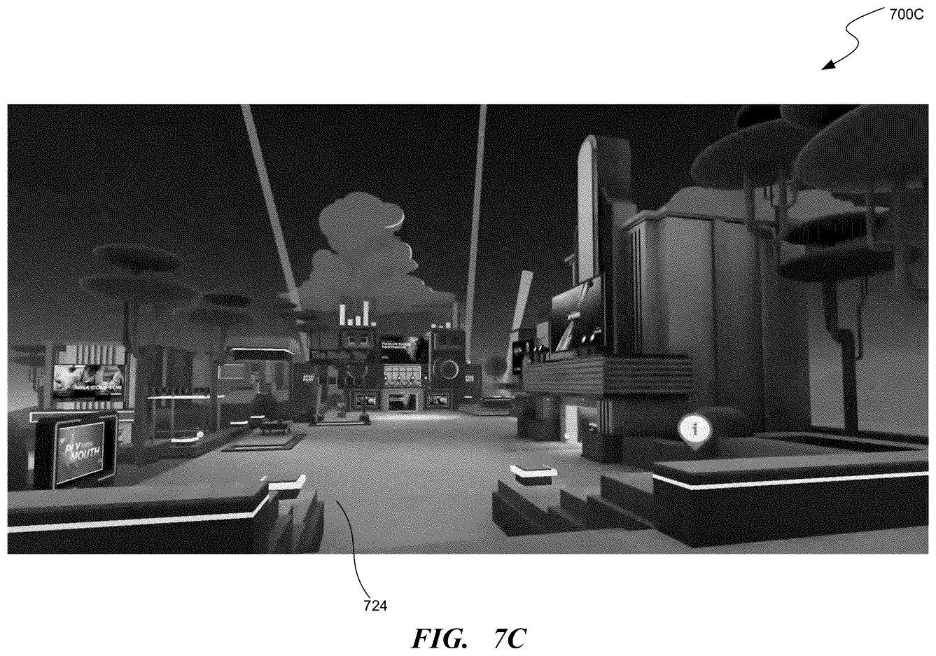

FIG. 7A is a conceptual diagram illustrating an example 700A of a virtual menu 702 displayed in an origin virtual world 704 to request generation of a virtual portal to a destination virtual world 724. Virtual menu 702 can include a plurality of descriptions 706A-106C of virtual worlds. Upon selection of description 706A of destination virtual world 724, virtual menu 702 can display a virtual selectable element 708 (e.g., a button), which can be selected to generate a virtual portal to destination virtual world 724.

FIG. 7B is a conceptual diagram illustrating an example 700B of a virtual portal 710 in an origin virtual world 704 for travel to a destination virtual world 724. Virtual portal 710 can be displayed within origin virtual world 704 in which virtual menu 702 was displayed. In response to the selection of description 706A from virtual menu 702, some implementations can display virtual portal 710. In some implementations, virtual portal 710 can include a preview of destination virtual world 724. The preview can include a snapshot 712 of destination virtual world 724, a title 714 of destination virtual world 724, a name 716 of the creating user of virtual portal 710, and a countdown 718 of how long virtual portal 710 will be displayed in origin virtual world 704. Virtual portal 710 can further include a selectable element 720 that allows a user to travel through virtual portal 710 to destination virtual world 724, and a selectable element 722 that allows a user to close virtual portal 710 (i.e., such that users can no longer travel to destination virtual world 724). Some implementations can display only one virtual portal 710 in the origin virtual world at a time; thus, selection of selectable element 722 can allow other user devices to request generation of a new virtual portal. In addition, expiration of countdown 718 can cause virtual portal 710 to close, thus allowing other user devices to request generation of a new virtual portal.

Some implementations can display virtual portal 710 to all of the user devices accessing origin virtual world 704 that have the virtual portal within their field-of-view. However, as described further herein, some implementations can restrict access to the virtual portal to only some of the user devices in origin virtual world 704. For example, various implementations can allow only those user devices associated with avatars within a threshold virtual distance in origin virtual world 704 of the avatar associated with the user device that spawned virtual portal 710 via virtual selectable element 708; can only show the portal 710 to users identified as friends on a social graph with the user device that spawned virtual portal 710, can only show the portal 710 to users who have received a key or otherwise been granted access by the user device that spawned virtual portal 710, etc.

FIG. 7C is a conceptual diagram illustrating an example 700C of destination virtual world 724 when accessed via virtual portal 710. For example, in response to a selection of selectable element 720, an avatar associated with the user device spawning virtual portal 710 (and/or other avatars within a threshold virtual distance of the creating user's avatar) can travel through virtual portal 710. Some implementations can then display destination virtual world 724 on the user device(s) selecting selectable element 720. In some implementations, all user devices accessing destination virtual world 724 via virtual portal 710 can be included in a same instance of destination virtual world 724. In other words, virtual portal 710 can reserve spots within the same instance of destination virtual world 724 for the user device spawning virtual portal 710 and other user devices having avatars within a threshold virtual distance of the creating user's avatar in the origin virtual world.

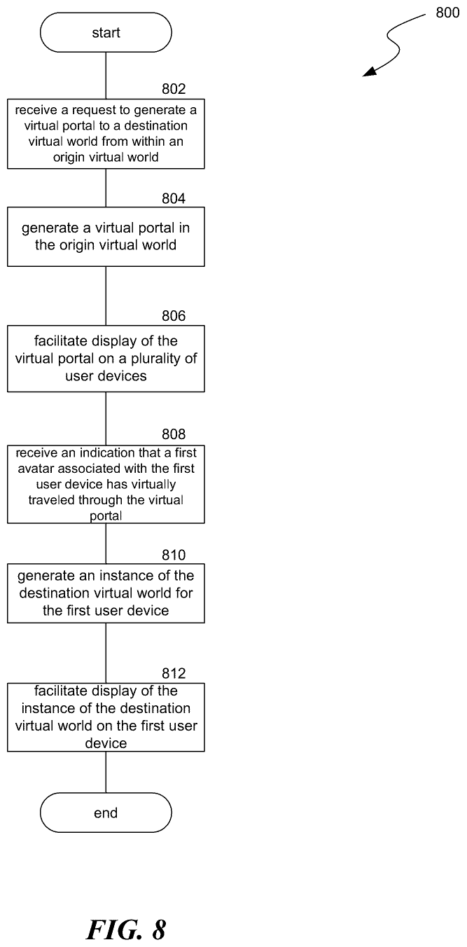

FIG. 8 is a flow diagram illustrating a process used in some implementations for traveling from an origin virtual world to a destination virtual world in an XR experience. In some implementations, process 800 can be performed as a response to a user request to generate a virtual portal to the destination virtual world. In some implementations, process 800 can be performed by a server in communication with a user device accessing the XR experience. In some implementations, process 800 can be performed by a user device accessing the XR experience, such as an XR interface (e.g., a head-mounted display (HMD), as described further herein) or a two-dimensional (2D) interface (e.g., a mobile phone, a tablet, a computer, etc.). In some implementations, one or more blocks of process 800 can be performed remotely by a server, while one or more other blocks of process 800 can be performed locally by a user device.

At block 802, process 800 can receive a request to generate a virtual portal to a destination virtual world, from within an origin virtual world, from a first user device of a plurality of user devices accessing the origin virtual world. The plurality of user devices can include any devices capable of accessing an XR experience, such as, for example, XR interfaces (e.g., HMDs), 2D interfaces (e.g., mobile phones, tablets, computers, etc.), or combinations thereof. In some implementations, process 800 can receive the request to generate the virtual portal via a menu listing available destination virtual worlds to which the first user device can request travel. The menu can include, for example, a button or other selectable element associated with requesting generation of the virtual portal. Process 800 can facilitate display of the menu while the first user device is accessing the origin virtual world.

At block 804, process 800 can, in response to receiving the request to generate the virtual portal, generate the virtual portal to the destination virtual world in the origin virtual world. The virtual portal can be, for example, a virtual doorway, a selectable virtual object, a virtual gate, or any other virtual entrance or object indicative of virtual travel to the destination virtual world. The virtual portal can be displayed in the origin virtual world in which the first user device requested generation of the virtual portal. In some implementations, the virtual portal can include a preview of the destination virtual world. For example, the virtual portal can include a snapshot of the destination virtual world, a name of the destination virtual world, a description of the destination virtual world, who created the virtual portal, etc. In some implementations, the virtual portal can further include a countdown of how long the virtual portal is available.

At block 806, process 800 can facilitate display of the virtual portal on the plurality of user devices accessing the origin virtual world. In some implementations, process 800 can facilitate display of the virtual portal to all of the user devices in the origin virtual world that have the virtual portal within their field-of-view. However, as described further herein, process 800 can restrict access to the virtual portal to some of the user devices in the origin virtual world. In some implementations, process 800 can restrict display of the virtual portal to friends, members of a same party, certain types of users (e.g., users having particular experiences, particular capabilities, and/or particular demographics), etc., within the origin virtual world.

In some implementations, process 800 can facilitate display of only one virtual portal in the origin virtual world, or within a threshold distance of another virtual portal, at a time. For example, if another user device requests generation of a new virtual portal in the same world or within a threshold distance of another virtual portal, process 800 can destroy the previous virtual portal. In some implementations, process 800 can facilitate display of the virtual portal for only a predetermined amount of time, e.g., 45 seconds, such that other user devices can request generation of new virtual portals upon expiration of the previous virtual portal. In some implementations, the user associated with the first user device can proactively close the virtual portal.

In some implementations, process 800 can facilitate display of the virtual portal by applying and/or controlling lighting effects applied to the user device to render the virtual portal. In some implementations, process 800 can facilitate display of the virtual portal by generating, transmitting, and/or interpreting rendering data user to create the virtual portal.

At block 808, process 800 can receive an indication that a first avatar associated with the first user device has virtually traveled through the virtual portal. In some implementations, a user of the first user device can use an input device to indicate that he wishes to travel to the destination virtual world through the virtual portal. For example, the user can use controllers, make gestures and/or movements, tap, click, etc., the virtual portal as displayed on the first user device to cause the first avatar to enter the virtual portal toward the destination virtual world.

At block 810, process 800 can, in some implementations, generate an instance of the destination virtual world for the first user device in response to receiving the indication. The instance of the destination virtual world can guarantee access by one or more second user devices of the plurality of user devices that are associated with respective one or more second avatars, the one or more second avatars being within a threshold virtual distance of the first avatar associated with the first user device within the origin virtual world. In other words, process 800 can reserve spots in the instance of the destination virtual world for avatars that are within a threshold virtual distance of the first avatar associated with the user that requested creation of the virtual portal. In some implementations, process 800 can reserve these spots for a predetermined amount of time, e.g., 1 minute. In some implementations, process 800 can associate the first user device with an existing instance of the destination virtual world in response to receiving the indication, if there are enough spots reserved in the existing instance to accommodate the first user device. The existing instance of the destination virtual world can include other users who have already traveled to that instance of the destination virtual world.

The threshold virtual distance can be any suitable distance from the first avatar in the origin virtual world, such as within reach of the first avatar, within the field-of-view of the first avatar, within a virtual radius of the first avatar, etc. Thus, in some implementations, not all of the plurality of user devices accessing the origin virtual world can travel to the instance of the destination virtual world via the virtual portal, although process 800 can nevertheless facilitate display of the virtual portal to all of the plurality of user devices having the virtual portal within their field-of-view.

At block 812, process 800 can facilitate display of the instance of the destination virtual world on the first user device. In some implementations, process 800 can facilitate display of the instance of the destination virtual world by applying and/or controlling lighting effects applied to the user device to render the instance of the destination virtual world. In some implementations, process 800 can facilitate display of the instance of the destination virtual world by generating, transmitting, and/or interpreting rendering data user to create the instance of the destination virtual world.

In some implementations, one or more of the second user devices having second avatars within the threshold virtual distance of the first avatar can also access the instance of the destination virtual world. For example, one or more of the second user devices can select the virtual portal and travel to the same instance of destination virtual world within which the first avatar is located. In such implementations, process 800 can facilitate display of the one or more second avatars in the instance of the destination virtual world. However, in some implementations, it is contemplated that the user associated with the first user device can remove one or more of the second user devices allowed to access the virtual portal, and thus the same instance of the destination virtual world. In some implementations, the first user can add one or more additional user devices that can access the same instance of the destination virtual world, regardless of whether their avatars are within the threshold virtual distance of the first avatar, and/or whether their user devices are accessing the origin virtual world.

Although described herein as traveling between an origin virtual world and a destination virtual world, it is contemplated that the virtual portals described herein can be used to travel between any origin and destination in an XR experience. For example, the virtual portals described herein can allow virtual travel between virtual universes controlled by different entities, applications on the same user device that have multiplayer capabilities, etc.

The implementations described herein are directed to providing invitation links to artificial reality (XR) destinations. Some implementations can transmit an invitation link associated with an XR destination to a user interface, such as an XR interface (e.g., an XR head-mounted display (HMD)) or a two-dimensional (2D) interface (e.g., a laptop, a tablet, a mobile phone, etc.). Upon activation of the invitation link by a user, some implementations can present a webpage from which the user can select one of her associated XR or 2D interfaces to load the XR destination. Some implementations can then transmit a command to the selected user interface to load the XR destination next time the selected user interface is powered on or donned (in the case of an XR HMD).

For example, a user can use an application on a mobile phone to receive an invitation link to an XR destination, e.g., a virtual world called “Neighborhoods,” either in response to a request from her, or in response to a request from another user. The user can click on the link to open a webpage displaying a preview and description of Neighborhoods, as well as a list of user interfaces associated with the user (e.g., an HMD and the mobile phone). The user can select her HMD from the list of user interfaces. At any point thereafter, the user can don her HMD and be automatically transported to Neighborhoods via the HMD.

As used herein, an “XR interface” can be a device capable of displaying an immersive XR experience, such as an MR or VR head-mounted display (HMD) within an XR system. In some implementations, the XR system can include devices and components other than the XR interface to support the XR experience, such as processing components, input/output devices (e.g., controllers), etc. Such components are described further herein.

A “2D interface” can be an application or device that can render an XR environment on a 2D surface. For example, a 2D interface can be a computer screen, television display, mobile device (e.g., cellular phone), mobile application, web browser, etc. The 2D interface can be part of a 2D system including other devices and components, such as processing components, input/output devices, etc.

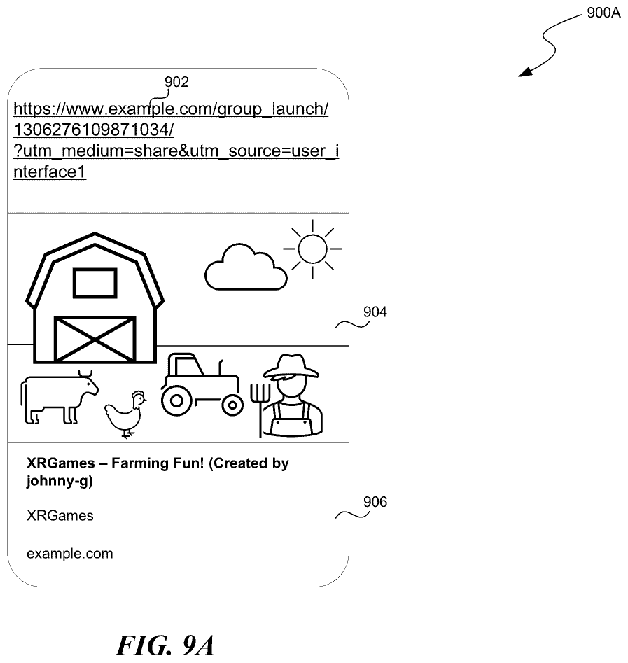

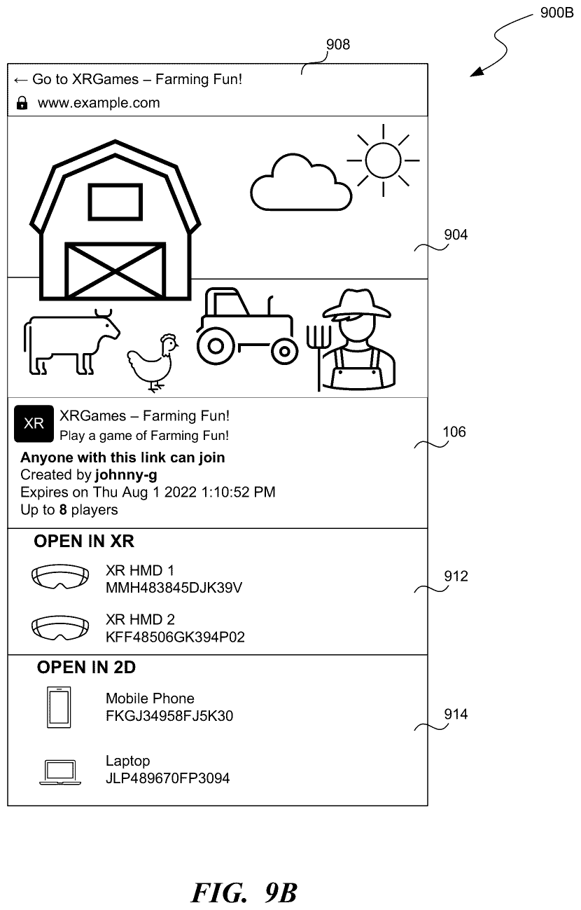

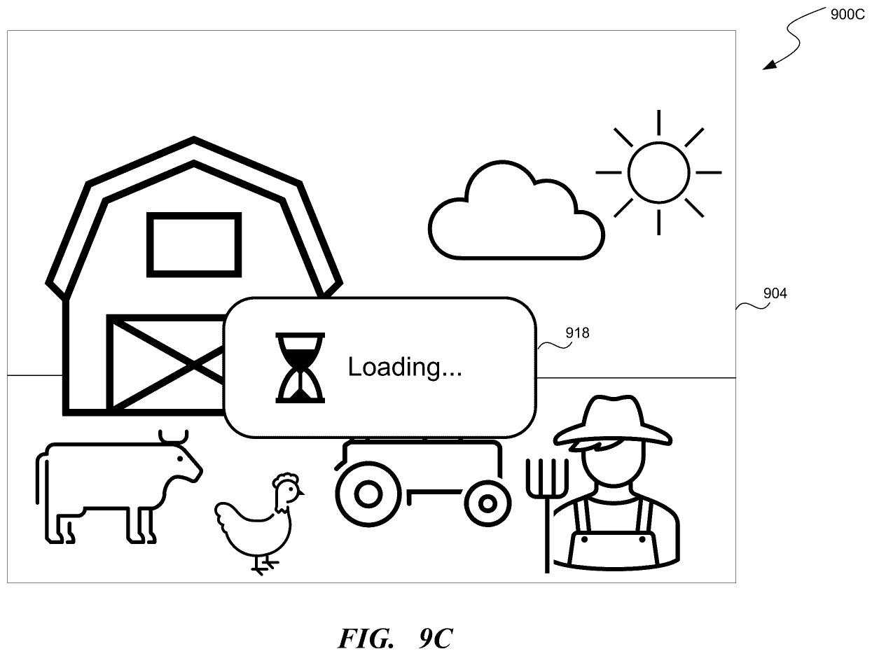

FIG. 9A is a conceptual diagram of an example message 900A including an invitation link to an XR destination. Message 900A can include an invitation link 902; in this case, a Uniform Resource Locator (URL) specifying a website address, e.g., “https://www.example.com/group_launch/1306276109871034/?utm_medium=share&u tm_source=user_interface1”. Although shown as a textual invitation link 902, it is contemplated that invitation link 902 can be graphical in some implementations. For example, message 900A can include a preview 904 of the XR destination that can be selected to access the URL.

Message 900A can be received and displayed on an XR interface and/or a 2D interface. In some implementations, invitation link 902 can specify the user interface requesting and/or receiving invitation link 902, e.g., “user_interface1”). Message 900A can be received via any suitable messaging method, such as through a text message or multimedia message, through a messaging application, or through any other application capable of sending and/or receiving and processing invitation link 902 (e.g., a social media application).

In some implementations, message 900A can include the preview 904 (e.g., a snapshot) of the XR destination. In some implementations, message 900A can further include metadata 906 associated with the XR destination. For example, metadata 906 can include a name of the XR destination (e.g., “Farming Fun!”), a name of the application needed to render the XR destination (e.g., “XRGames”), and a creator of the XR destination (e.g., “johnny-g”).

FIG. 9B is a conceptual diagram of an example user interface selection page 900B that can be displayed upon activation (e.g., selection) of invitation link 902 associated with an XR destination. In some implementations, user interface selection page 900B can be a webpage. User interface selection page 900B can include a header 908, preview 904 of the XR destination (e.g., “Farming Fun!”), metadata 906 associated with the XR destination, and lists 912, 914 of user interfaces associated with a user activating invitation link 902. List 912 can specify XR interfaces associated with the user that are capable of rendering the XR destination (e.g., XR HMD 1 and XR HMD 2, as well as their respective associated identifiers, such as hardware addresses), while list 914 can specify 2D interfaces capable of rendering the XR destination (e.g., mobile phone and laptop, as well as their respective associated identifiers, such as hardware addresses).

From user interface selection page 900B, the user can select a user interface from lists 912, 914 on which he would like to access the XR destination. In response to receiving the selection, some implementations can generate and transmit a command to the selected user interface to automatically load the XR destination upon powering on, donning of the selected user interface, activation of an application on the selected user interface corresponding to the destination, etc. For example, if the user selects XR HMD 1 from list 912, some implementations can automatically load the XR destination on XR HMD 1 when the user dons XR HMD 1. In another example, if the user selects “Laptop” from list 914, some implementations can automatically load the XR destination on the laptop when the laptop is turned on. In yet a further example, if the user selects “Mobile Phone” from list 914, some implementations can automatically load the XR destination on the mobile phone when a web browser application is executed one the mobile phone.

FIG. 9C is a conceptual diagram of an example landing page 900C that can be displayed upon loading a destination. Once a user interface is selected from lists 912, 914, some implementations can automatically display landing page 900C when the selected user interface is powered on or donned, while the XR destination specified by invitation link 902 is automatically loading. Landing page 900C can include preview 904 of the XR destination and a status bar 918 showing the status of the loading of the XR destination. In some implementations, if the selected user interface is powered on upon selection from lists 912, 914, the selected user interface can preload some or all of the data needed to render the XR destination. Thus, in some implementations, landing page 900C can be bypassed, and the XR destination can be automatically loaded.

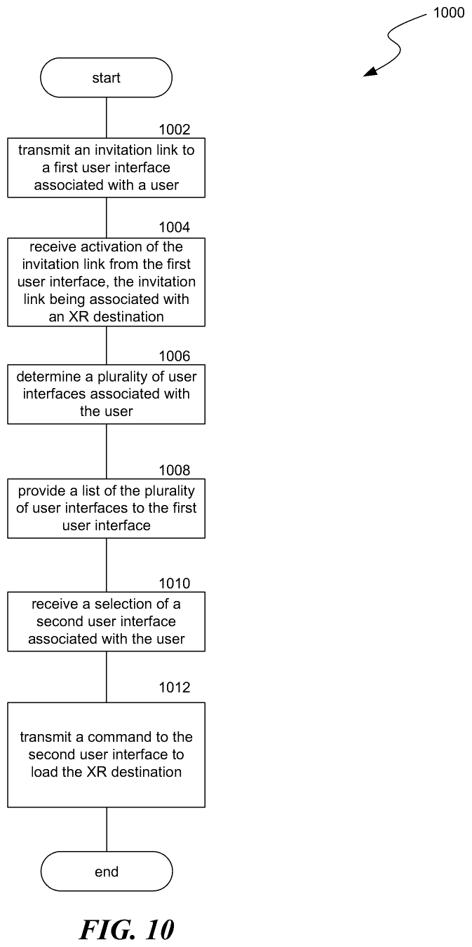

FIG. 10 is a flow diagram illustrating a process 1000 used in some implementations for providing an invitation link to an XR destination. In some implementations, process 1000 can be performed as a response to a user request to generate the invitation link to the XR destination. In some implementations, the user request can be made by a user wanting to himself travel to the XR destination. In some implementations, the user request can be made by a user wanting another user to travel with her to the XR destination. In some implementations, some or all of process 1000 can be performed by a user interface, such as an XR interface or a 2D interface, and/or other components of a system in operable communication with and local to the user interface. In some implementations, some or all of process 1000 can be performed by a server located remotely from a user interface. In some implementations, some of process 1000 can be performed by a user interface, while some of process 1000 can be performed by a remote server. In some implementations, process 1000 can be performed by the XR destination invitation link system described further herein.

At block 1002, process 1000 can transmit an invitation link to a first user interface of a plurality of user interfaces associated with a user. The plurality of user interfaces can include XR interface(s), 2D interface(s), or a combination thereof. In some implementations, process 1000 can transmit the invitation link to the first user interface in response to a request by the user via the first user interface. In some implementations, process 1000 can transmit the invitation link to the first user interface in response to a request from a user other than the user of the first user interface, such as from another user wanting to travel to a same XR destination with the user of the first user interface.

In some implementations, the invitation link can be transmitted in a message including a preview (e.g., a snapshot) of the XR destination and metadata, such as information about the XR destination, e.g., its name, its creator, which application loads it, a virtual location within the XR destination, when the XR destination and/or the invitation link expires, etc., as described further herein. Process 1000 can transmit the invitation link via any suitable messaging method, such as through a text message or multimedia message, through a messaging application, or through any other application capable of sending and/or receiving and processing selectable invitation links, such as a social media application.

At block 1004, process 1000 can receive activation of the invitation link from the first user interface. The invitation link can be associated with an XR destination. In some implementations, the invitation link can be a textual hyperlink to a Uniform Resource Locator (URL). In some implementations, the invitation can be a graphical hyperlink to a URL. In some implementations, activation of the invitation link can be a selection of the invitation link by the user on the first user interface.

At block 1006, in response to receiving activation of the invitation link, process 1000 can determine the plurality of user interfaces associated with the user. In some implementations, the invitation link can be unique to the first user interface and/or the user, such that process 1000 can identify the first user interface and/or the user based on a string of characters in the invitation link. In some implementations, process 1000 can identify the user by requiring that the user log in to a user account upon activation of the invitation link. In some implementations, process 1000 can identify the first user interface from metadata received with the activation of the invitation link. In some implementations, process 1000 can identify the user upon identification of the first user interface by accessing a database or lookup table storing an identifier of the first user interface in association with an identifier of the user. Similarly, once the user is identified, process 1000 can determine the plurality of user interfaces associated with the user by accessing a database or lookup table storing identifiers of the plurality of user interfaces in association with an identifier of the user.

At block 1008, process 1000 can provide a list of the plurality of user interfaces associated with the user to the first user interface. In some implementations, process 1000 can transmit the list of the plurality of user interfaces via a webpage specified by the invitation link. The plurality of user interfaces can include some or all of the user interfaces associated with a user that are capable of rendering the XR destination.

At block 1010, process 1000 can receive a selection of a second user interface from the list of the plurality of user interfaces associated with the user. The user can select the second user interface based on which user interface of the plurality of her user interfaces she wishes to access the XR destination. In some implementations, the first user interface and the second user interface can be the same user interface, e.g., if the user activates the % IF invitation link on her mobile phone, she can select the same mobile phone from the list. In some implementations, the first user interface and the second user interface can be different user interfaces, e.g., the user can activate the invitation link on her mobile phone, but select her XR HMD from the list of user interfaces.

At block 1012, process 1000 can, in response to receiving the selection, transmit a command to the second user interface to automatically load the XR destination, e.g., upon powering on or donning of the second user interface, loading a corresponding application, or other triggering event. In some implementations, if the user selected a 2D interface from the list of user interfaces, process 1000 can transmit a command to the 2D interface to automatically load the XR destination when the 2D interface is turned on, when an application capable of rendering the XR destination is opened, when the 2D interface is awakened from a sleep or power saving mode, when the 2D interface has sufficient power, bandwidth, or processing capabilities, etc. In some implementations, if the user selected an XR interface to automatically load the XR destination, process 1000 can transmit a command to the XR interface to automatically load the XR destination when the XR interface is turned on, when an application capable of rendering the XR destination is opened, when the XR interface is awakened from a sleep or power saving mode, when the XR interface has sufficient power, bandwidth, or processing capabilities, and/or when the XR interface is donned (e.g., when an XR HMD is placed on the head of the user, as detected by the XR HMD). In some implementations, if the second user interface is powered on when the command is received, the second user interface can preload some or all of the data needed to render the XR destination, such that loading of the XR destination on the second user interface is faster upon, for example, donning of the second user interface and/or when any of the other above-described conditions are satisfied.

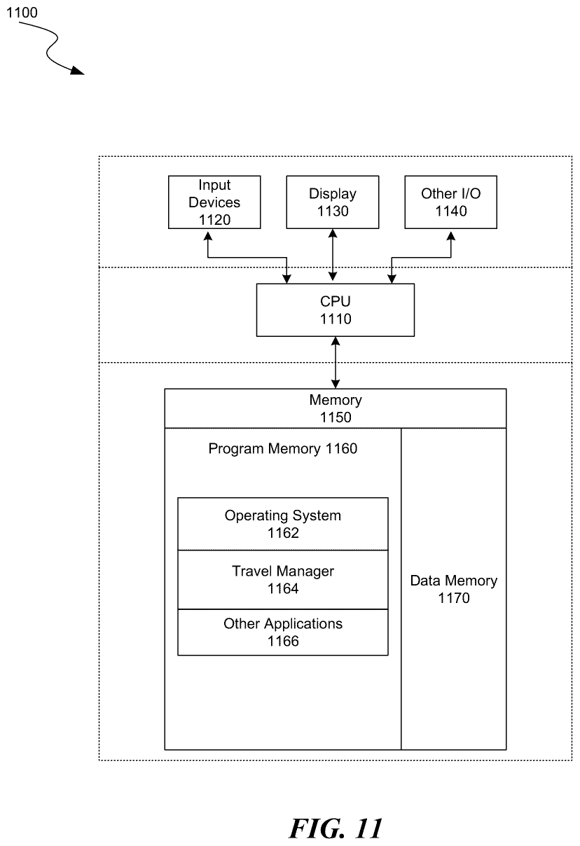

FIG. 11 is a block diagram illustrating an overview of devices on which some implementations of the disclosed technology can operate. The devices can comprise hardware components of a device 1100 as shown and described herein. Device 1100 can include one or more input devices 1120 that provide input to the Processor(s) 1110 (e.g., CPU(s), GPU(s), HPU(s), etc.), notifying it of actions. The actions can be mediated by a hardware controller that interprets the signals received from the input device and communicates the information to the processors 1110 using a communication protocol. Input devices 1120 include, for example, a mouse, a keyboard, a touchscreen, an infrared sensor, a touchpad, a wearable input device, a camera- or image-based input device, a microphone, or other user input devices.

Processors 1110 can be a single processing unit or multiple processing units in a device or distributed across multiple devices. Processors 1110 can be coupled to other hardware devices, for example, with the use of a bus, such as a PCI bus or SCSI bus. The processors 1110 can communicate with a hardware controller for devices, such as for a display 1130. Display 1130 can be used to display text and graphics. In some implementations, display 1130 provides graphical and textual visual feedback to a user. In some implementations, display 1130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1140 can also be coupled to the processor, such as a network card, video card, audio card, USB, firewire or other external device, camera, printer, speakers, CD-ROM drive, DVD drive, disk drive, or Blu-Ray device.

In some implementations, the device 1100 also includes a communication device capable of communicating wirelessly or wire-based with a network node. The communication device can communicate with another device or a server through a network using, for example, TCP/IP protocols. Device 1100 can utilize the communication device to distribute operations across multiple network devices.

The processors 1110 can have access to a memory 1150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1150 can include program memory 1160 that stores programs and software, such as an operating system 1162, travel manager 1164, and other application programs 1166. Memory 1150 can also include data memory 1170, which can be provided to the program memory 1160 or any element of the device 1100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

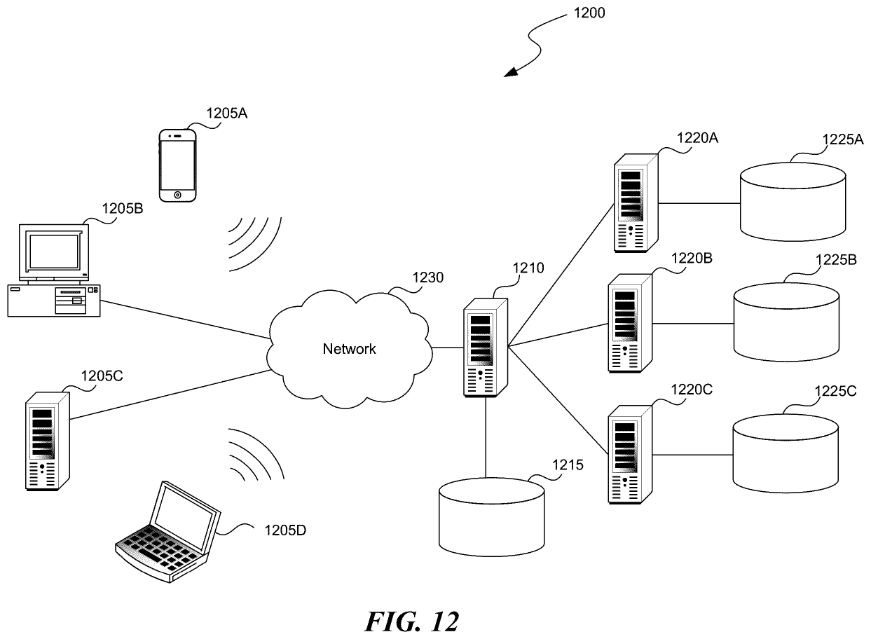

FIG. 12 is a block diagram illustrating an overview of an environment 1200 in which some implementations of the disclosed technology can operate. Environment 1200 can include one or more client computing devices 1205A-D, examples of which can include device 1100. Client computing devices 1205 can operate in a networked environment using logical connections through network 1230 to one or more remote computers, such as a server computing device.

In some implementations, server 1210 can be an edge server which receives client requests and coordinates fulfillment of those requests through other servers, such as servers 1220A-C. Server computing devices 1210 and 1220 can comprise computing systems, such as device 1100. Though each server computing device 1210 and 1220 is displayed logically as a single server, server computing devices can each be a distributed computing environment encompassing multiple computing devices located at the same or at geographically disparate physical locations. In some implementations, each server 1220 corresponds to a group of servers.

Client computing devices 1205 and server computing devices 1210 and 1220 can each act as a server or client to other server/client devices. Server 1210 can connect to a database 1215. Servers 1220A-C can each connect to a corresponding database 1225A-C. As discussed above, each server 1220 can correspond to a group of servers, and each of these servers can share a database or can have their own database. Databases 1215 and 1225 can warehouse (e.g., store) information. Though databases 1215 and 1225 are displayed logically as single units, databases 1215 and 1225 can each be a distributed computing environment encompassing multiple computing devices, can be located within their corresponding server, or can be located at the same or at geographically disparate physical locations.

Network 1230 can be a local area network (LAN) or a wide area network (WAN), but can also be other wired or wireless networks. Network 1230 may be the Internet or some other public or private network. Client computing devices 1205 can be connected to network 1230 through a network interface, such as by wired or wireless communication. While the connections between server 1210 and servers 1220 are shown as separate connections, these connections can be any kind of local, wide area, wired, or wireless network, including network 1230 or a separate public or private network.

In some implementations, servers 1210 and 1220 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events, Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system, Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for traveling a user from a source environment to a target artificial reality (XR) environment, the method comprising:
receiving, from a user, input that triggers a transition into the target XR environment, wherein the source environment for the user includes a two-dimensional browser display, a three-dimensional browser display, a source XR environment, or any combination thereof;
displaying, to the user, a travel experience while loading the target XR environment, wherein the travel experience comprises at least a display element that includes one or more of: a) an identifier for the target XR environment; b) contextual information for the target XR environment; c) social connections for the user present in the target XR environment; d) a depicture of the user's presence within in the target XR environment; e) or any combination thereof; and
dynamically transitioning the display to the user from the travel experience to the target XR environment when the target XR environment is loaded.

2. A method for traveling from an origin virtual world to a destination virtual world in an artificial reality experience, the method comprising:
receiving a request to generate a virtual portal to the destination virtual world;
in response to receiving the request to generate the virtual portal, generating the virtual portal to the destination virtual world in the origin virtual world;
facilitating display of the virtual portal;
receiving an indication that a first avatar associated with the first user device has virtually traveled through the virtual portal; and
in response to receiving the indication, generating an instance of the destination virtual world for the first user device.

3. A method for providing an invitation link to an artificial reality destination, the method comprising:
transmitting the invitation link, to a first user interface of a plurality of user interfaces associated with a user, the invitation link being associated with the artificial reality destination;
receiving activation of the invitation link from the first user interface;
providing a list of the plurality of user interfaces associated with the user to the first user interface;
receiving a selection of a second user interface from the list of the plurality of user interfaces associated with the user; and
in response to receiving the selection, transmitting a command to the second user interface to automatically load the artificial reality destination.
